(19) United States
(12) Patent Application Publication
(10) Pub. No.: US 2026/0007969 A1
(43) Pub. Date: Jan. 8, 2026

(54) CONTROLLING NON-PLAYER CHARACTER

(71) Applicant: Tencent Technology (Shenzhen) Company Limited, Shenzhen (CN)

(72) Inventor: Jintian HUANG, Shenzhen (CN)

(73) Assignee: Tencent Technology (Shenzhen) Company Limited, Shenzhen, GD (CN)

(21) Appl. No.: 19/260,044

(22) Filed: Jul. 3, 2025

Related U.S. Application Data
(63) Continuation of application No. PCT/CN2024/081676, filed on Mar. 14, 2024.

(30) Foreign Application Priority Data
May 16, 2023 (CN) 202310548686.7

(51) Int. Cl. A63F 13/55; A63F 13/44; A63F 13/67; A63F 13/822

(52) U.S. Cl. CPC A63F 13/55; A63F 13/44; A63F 13/67; A63F 13/822

(57) ABSTRACT

In a method for controlling a non-player character (NPC), each of a plurality of NPCs in an NPC group is controlled through a respective individual control logic of a plurality of individual control logics and a status parameter of the respective NPC. The status parameter corresponding to at least a first NPC in the NPC group is modified, by processing circuitry and through a group control logic, based on a modifying condition between a virtual character and a first NPC in the NPC group. An interaction between the NPC and the virtual character is controlled, through the individual control logic of the NPC, based on the modified status parameter of the NPC. Apparatus and non-transitory computer-readable storage medium counterpart embodiments are also contemplated.

### RELATED APPLICATIONS

The application is a continuation of International Application No. PCT/CN2024/081676, entitled “NON-PLAYER CHARACTER CONTROL METHOD AND APPARATUS, AND DEVICE, MEDIUM AND PROGRAM PRODUCT” and filed on Mar. 14, 2024, which claims priority to Chinese Patent Application No. 202310548686.7, entitled “METHOD AND APPARATUS FOR CONTROLLING NON-PLAYER CHARACTER, DEVICE, MEDIUM, AND PROGRAM PRODUCT” and filed on May 16, 2023, which are incorporated herein by reference in their entirety.

### FIELD OF THE TECHNOLOGY

Embodiments of this disclosure relate to the field of computer technologies, including to a method and an apparatus for controlling a non-player character, a device, a medium, and a program product.

### BACKGROUND OF THE DISCLOSURE

In a virtual environment-based application, such as a massive multi-player online game (MMOG), a user may control a virtual character to move in the virtual environment. In addition, a non-player character (NPC) also exists in the virtual environment. The NPC may interact with the virtual character controlled by the user, for example, attack the virtual character controlled by the user, or the NPC can push a plot attached with a task or help the user complete a task.

In the related art, behavior control logic of the NPC is set in group control logic, and one group control logic corresponds to a plurality of NPCs. Instructions are delivered to individuals of the plurality of NPCs by using the group control logic, and the plurality of NPCs respectively perform a behavior corresponding to the received instruction.

However, the related art is only applicable to a case in which a behavior of an individual NPC and a condition for determining a behavior are simple, for example, birth of the NPC. When the behavior performed by the individual NPC and the condition for determining the behavior are complex, for example, a complex action game, the related art is not applicable.

### SUMMARY

This disclosure provides a method and an apparatus for controlling a non-player character, a device, a medium, and a program product. Examples of technical solutions are as follows:

According to an aspect of this disclosure, a method for controlling a non-player character (NPC) is provided. In the method, each of a plurality of NPCs in an NPC group is controlled through a respective individual control logic of a plurality of individual control logics and a status parameter of the respective NPC. The status parameter corresponding to at least a first NPC in the NPC group is modified, by processing circuitry and through a group control logic, based on a modifying condition between a virtual character and the first NPC in the NPC group. An interaction between the NPC and the virtual character is controlled, through the individual control logic of the NPC, based on the modified status parameter of the NPC.

According to an aspect of this disclosure, an information processing apparatus including processing circuitry is provided. The processing circuitry is configured to control each of a plurality of non-player characters (NPCs) in an NPC group through a respective individual control logic of a plurality of individual control logics and a status parameter of the respective NPC. The processing circuitry is configured to modify, through a group control logic, the status parameter corresponding to at least a first NPC in the NPC group based on a modifying condition between a virtual character and the first NPC in the NPC group. The processing circuitry is configured to control, through the individual control logic of the NPC, an interaction between the NPC and the virtual character based on the modified status parameter of the NPC.

According to an aspect of this disclosure, a non-transitory computer-readable storage medium is provided. The non-transitory computer-readable storage medium storing instructions which when executed by a processor cause the processor to perform the method for controlling the NPC.

According to an aspect of this disclosure, a method for controlling a non-player character is provided. The method includes: obtaining group control logic and respective individual control logic of a plurality of NPCs, the group control logic being control logic corresponding to an NPC group, and the NPC group including the plurality of NPCs; modifying, by using the group control logic, a status parameter corresponding to at least one NPC in the NPC group in response to an influencing factor between a virtual character and a first NPC in the NPC group; and updating an interaction situation between the at least one NPC and the virtual character based on a modified status parameter corresponding to the at least one NPC and the individual control logic of the at least one NPC.

According to another aspect of this disclosure, an apparatus for controlling a non-player character is provided. The apparatus includes: an obtaining module, configured to obtain group control logic and respective individual control logic of a plurality of NPCs, the group control logic being control logic corresponding to an NPC group, and the NPC group including the plurality of NPCs; a control module, configured to: modify, by using the group control logic, a status parameter corresponding to at least one NPC in the NPC group in response to an influencing factor between a virtual character and a first NPC in the NPC group; and an update module, configured to update an interaction situation between the at least one NPC and the virtual character based on a modified status parameter of the at least one NPC and the individual control logic of the at least one NPC.

According to another aspect of this disclosure, a computer device is provided. The computer device includes: a processor and a memory, the memory having at least one computer program stored therein, and the at least one computer program being loaded and executed by the processor to implement the method for controlling a non-player character according to the foregoing aspects.

According to another aspect of this disclosure, a computer-readable storage medium, such as a non-transitory computer-readable storage medium, is provided. The computer-readable storage medium has at least one computer program stored therein, and the at least one computer program is loaded and executed by a processor to implement the method for controlling a non-player character according to the foregoing aspects.

According to another aspect of this disclosure, a computer program product is provided. The computer program product includes a computer program, the computer program being stored in a computer-readable storage medium; and the computer program being read and executed by a processor of a computer device from the computer-readable storage medium, to cause the computer device to implement the method for controlling a non-player character according to the foregoing aspects.

The technical solutions provided in this disclosure include at least the following beneficial effects:

In this disclosure, status parameters of NPCs in the group are modified by using the group control logic, and then the interaction situation between each NPC and the virtual character is updated by using respective individual control logic of each NPC in combination with the status parameter of each NPC. This disclosure provides a status parameter-based NPC communication solution. An NPC group communicates with an NPC individual by using the status parameter. Behavior control logic of the NPC is mainly located on the individual control logic, and switching (for example, only switching) of the status parameter is performed by the group control logic, so that the behavior control logic of the NPC is more systematic. This disclosure further supports customizing behaviors of the NPC in different states (status parameters), and respective individual control logic of each NPC may be customized according to requirements, so that an interaction activity between the NPC and the virtual character is richer and more real.

### BRIEF DESCRIPTION OF THE DRAWINGS

FIG. 1 is a schematic diagram of a method for controlling a non-player character according to an embodiment of this disclosure.

FIG. 2 is a schematic diagram of an architecture of a computer system according to an embodiment of this disclosure.

FIG. 3 is a flowchart of a method for controlling a non-player character according to an embodiment of this disclosure.

FIG. 4 is a flowchart of a method for controlling a non-player character according to an embodiment of this disclosure.

FIG. 5 is a schematic diagram of association between individual control logic and group control logic according to an embodiment of this disclosure.

FIG. 6 is a schematic diagram of an interaction operation between a virtual character and an NPC according to an embodiment of this disclosure.

FIG. 7 is a flowchart of a method for controlling a non-player character according to an embodiment of this disclosure.

FIG. 8 is a flowchart of a method for controlling a non-player character according to an embodiment of this disclosure.

FIG. 9 is a schematic diagram of an interaction operation between a virtual character and an NPC according to an embodiment of this disclosure.

FIG. 10 is a flowchart of a method for controlling an NPC according to an embodiment of this disclosure.

FIG. 11 is a flowchart of a method for controlling an individual NPC according to an embodiment of this disclosure.

FIG. 12 is a flowchart of a method for controlling an NPC according to an embodiment of this disclosure.

FIG. 13 is a flowchart of a method for controlling an NPC according to an embodiment of this disclosure.

FIG. 14 is a block diagram of an apparatus for controlling a non-player character according to an embodiment of this disclosure.

FIG. 15 is a schematic diagram of a structure of a computer device according to an embodiment of this disclosure.

### DESCRIPTION OF EMBODIMENTS

First, terms involved in embodiments of this disclosure are introduced. The descriptions of the terms are provided as examples only and are not intended to limit the scope of the disclosure.

Virtual environment: It is a virtual environment displayed (or provided) when an application runs on a terminal. The virtual environment may be a simulated environment of a real world, or may be a semi-simulated and semi-fictional environment, or may be a completely fictional environment. The virtual environment may be any one of a two-dimensional virtual environment, a 2.5-dimensional virtual environment, and a three-dimensional virtual environment. This is not limited in this disclosure. An example in which the virtual environment is the three-dimensional virtual environment is used for description in the following embodiments.

Virtual character: It is a movable character in the virtual environment. The movable character may be a virtual person, a virtual animal, a cartoon character, or the like, for example, a person, an animal, a plant, a wall, a stone, or a water pool, displayed in the virtual environment. The virtual character is controlled by a user, and the virtual character may be classified according to jobs, for example, a pharmacist, a magician, or a medic; or the virtual character may be classified according to categories, for example, human, beasts, or fairies. Each virtual character has its own shape and volume in the virtual environment, and occupies some space in the virtual environment.

Massive multi-player online game MMOG: It is a game in which a server of the game can provide a large quantity of players online at the same time, and is also named massive multi-player online role-playing game (MMORPG). The game provides a virtual world for the user. In the game, the user may create the virtual character, and control the virtual character to perform a corresponding activity, to complete a task corresponding to the activity. Virtual characters controlled by a plurality of users may form a team, to complete the same task together, or battle against other teams.

Non-player character NPC: It is a virtual character in the game that is not controlled by the user. The NPC is a virtual character having a behavior mode of the NPC. Types of the NPC include: a plot NPC, a fight NPC, a service NPC, or the like. The plot NPC is an NPC that provides story plots or information for a virtual character controlled by the user. When the virtual character controlled by the user performs a task in the game, the task is attached with a corresponding story plot. In some embodiments, the NPC may give different feedbacks based on communication information or actions between the user and the plot NPC, for example, drop a virtual prop, provide prompt information, and release a new task. The fight NPC is an NPC that may fight with the virtual character controlled by the user, and the fight NPC may be a virtual character that belongs to the same team as the virtual character controlled by the user, or an NPC (that is, an enemy NPC) that needs to be attacked by the virtual character controlled by the user. The service NPC is an NPC that provides services for the virtual character controlled by the user. For example, the service NPC is a merchant virtual character or a tutor virtual character in the virtual environment. In some embodiments, such a type of NPC performs a fixed action or releases fixed information, and the virtual character controlled by the user receives services from the NPC, and obtains corresponding information, props, empirical values, and the like.

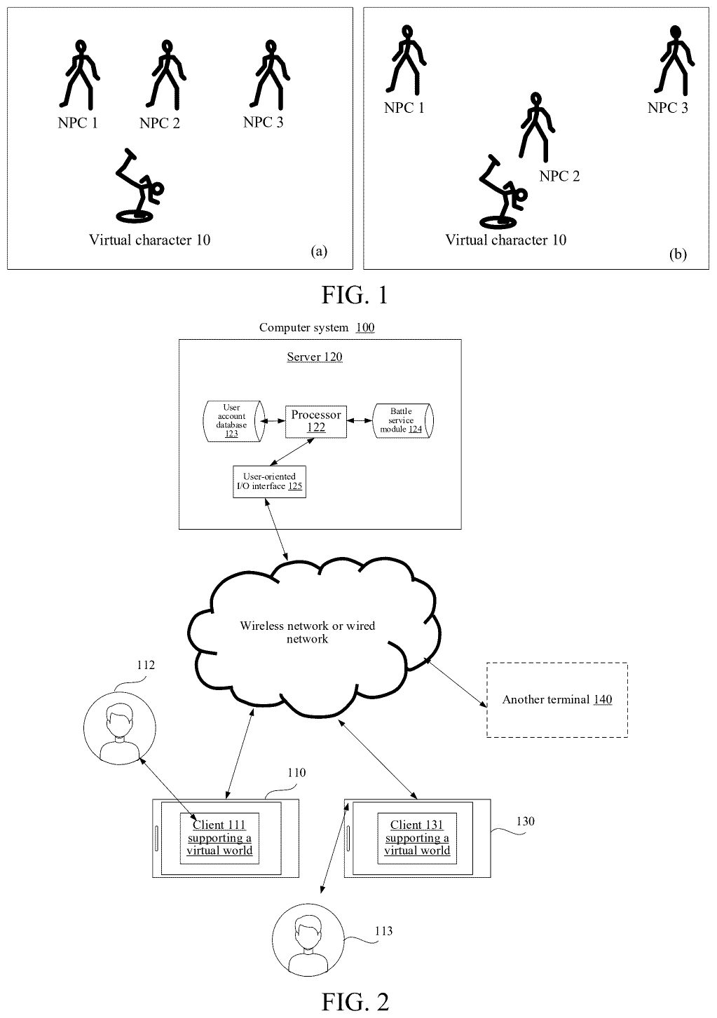

An embodiment of this disclosure provides a schematic diagram of a method for controlling a non-player character. As shown in FIG. 1, the method may be performed by a computer device, and the computer device may be a terminal or a server.

For example, as shown in a part (a) of FIG. 1, a game interface is displayed on a user interface, and the game interface includes a virtual character 10 and a plurality of NPCs. The computer device obtains group control logic and respective individual control logic of the plurality of NPCs, the group control logic being control logic corresponding to an NPC group, the NPC group including the plurality of NPCs, and the control logic being code logic for controlling actions of the NPCs. The computer device modifies, by using the group control logic, a status parameter corresponding to at least one NPC in the NPC group in response to an interaction operation between the virtual character 10 and a first NPC in the NPC group. The computer device updates an interaction situation between the at least one NPC and the virtual character based on a modified status parameter corresponding to the at least one NPC and individual control logic of the at least one NPC.

The NPC has a specific image. The NPC may be an NPC having a character image, or an NPC having an animal image, or an NPC having a mythical beast image or a fairy image, or an NPC having a natural landscape image, or an NPC having an artificial landscape image, but is not limited thereto. This is not specifically limited in the embodiments of this disclosure. The plurality of NPCs belong to the same NPC group.

In some embodiments, the interaction operation includes at least one of common attack, defense, ultimate skill releasing, type chat, voice chat, and gift giving, but is not limited thereto. This is not specifically limited in the embodiments of this disclosure.

The status parameter is configured for indicating a state of the NPC in the virtual environment. In some embodiments, the status parameter includes a parameter configured for describing at least one of an activated state or an idle state, but is not limited thereto. This is not specifically limited in the embodiments of this disclosure.

In some embodiments, the activated state is a state in which the NPC can actively interact with the virtual character 10. For example, the NPC can actively attack the virtual character 10. The idle state is a state in which the NPC cannot actively interact with the virtual character 10. For example, the NPC walks past the virtual character 10 and does not interact with the virtual character.

In some embodiments, the activated state is a state in which the NPC interacts with the virtual character 10 by releasing an ultimate skill. For example, the NPC can attack the virtual character 10 by releasing the ultimate skill. The ultimate skill is a skill having a higher attack value and a larger attack range. The idle state is a state in which the NPC interacts with the virtual character 10 by releasing a common attack skill.

In some embodiments, a state of the NPC in a fight is used as an example, and the activated state includes a striked state and an attacked state. The striked state is a state in which the NPC bears the ultimate skill released by the virtual character; and the attacked state is a state in which the NPC releases the ultimate skill to the virtual character.

For example, the computer device modifies, by using the group control logic, an initial status parameter corresponding to the at least one NPC in the NPC group in response to the virtual character 10 and the first NPC entering an interaction scene.

The initial status parameters are default status parameters of the NPCs in the NPC group when a battle starts.

For example, as shown in a part (a) of FIG. 1, the plurality of NPCs includes an NPC 1, an NPC 2, and an NPC 3. The NPC 1, the NPC 2, and the NPC 3 belong to the same NPC group, and default states of the NPC 1, the NPC 2, and the NPC 3 are idle states when the battle starts, that is, the NPC 1, the NPC 2, and the NPC 3 do not actively attack the virtual character 10.

For example, in a case that the virtual character 10 attacks the first NPC or the virtual character enters a field of view of the first NPC, the computer device modifies, by using the group control logic, the initial status parameter corresponding to the at least one NPC in the NPC group.

The field of view is a sector range using a position of the NPC as a center of a circle, or a circle range using a position of the NPC as a center of a circle, or a regular graphic range using a position of the NPC as a center, or an irregular graphic range using a position of the NPC as a center, but is not limited thereto. This is not specifically limited in the embodiments of this disclosure. A size of the field of view is not specifically limited.

As shown in a part (b) in FIG. 1, when the virtual character 10 enters a field of view of the NPC 2, the computer device modifies, by using the group control logic, initial status parameters corresponding to the NPC 1, the NPC 2, and the NPC 3, to modify the NPC 2 from an idle state to an activated state, and keep the NPC 1 and the NPC 3 to be in the idle state. In this case, the computer device updates interaction situations between the NPC 1, the NPC 2, and the NPC 3 and the virtual character 10 based on the status parameters respectively corresponding to the NPC 1, the NPC 2, and the NPC 3 and the individual control logic respectively corresponding to the NPC 1, the NPC 2, and the NPC 3. That is, the NPC 2 actively attacks the virtual character 10, and the NPC 1 and NPC 3 walk away.

In some embodiments, the computer device modifies, by using the group control logic, a status parameter of the first NPC from the activated state to the idle state and modifies a status parameter of a second NPC from the idle state to the activated state in response to duration of an interaction between the virtual character 10 and the first NPC reaching a time threshold.

For example, NPCs in the NPC group include the NPC 1, the NPC 2, and the NPC 3. When fight duration between the virtual character 10 and the NPC 2 reaches 20 s, the computer device modifies, by using the group control logic, status parameters of the NPC 1, the NPC 2, and the NPC 3, for example, modifies the status parameter of the NPC 2 from the activated state to the idle state, and modifies the status parameters of the NPC 1 and the NPC 3 from the idle state to the activated state. In other words, after attack duration between the virtual character 10 and the NPC 2 reaches 20 s, the NPC 2 no longer continues to fight with the virtual character 10, and the NPC 2 moves away from the virtual character 10, but the NPC 1 and the NPC 3 start to fight with the virtual character 10.

In some embodiments, the computer device modifies, by using the group control logic, the status parameter of the first NPC from the activated state to the idle state and modifies the status parameter of the second NPC from the idle state to the activated state in response to a sum of operation points of the interaction operation between the first NPC and the virtual character 10 reaching a point threshold.

For example, NPCs in the NPC group include the NPC 1, the NPC 2, and the NPC 3. In a process in which the virtual character 10 fights with the NPC 1, when the NPC 1 releases an ultimate skill each time, 5 points are added. In a case that the points reach 15 points, the computer device modifies, by using the group control logic, the status parameters of the NPC 1, the NPC 2, and the NPC 3, for example, modifies the status parameter of the NPC 1 from the activated state to the idle state, and modifies the status parameters of the NPC 2 and the NPC 3 from the idle state to the activated state. In other words, in the process in which the virtual character 10 fights with the NPC 1, after the NPC 1 releases three ultimate skills, the NPC 1 does not continue to fight with the virtual character 10, and the NPC 1 moves away from the virtual character 10, but the NPC 2 and the NPC 3 start to fight with the virtual character 10.

In some embodiments, an association relationship between the first NPC and a third NPC in the NPC group is obtained; the status parameters of the first NPC and the third NPC are modified, by using the group control logic, to be in a consistent state in a case that the first NPC and the third NPC are in a positive relationship; and the status parameters of the first NPC and the third NPC are modified, by using the group control logic, to be in an opposite state in a case that the first NPC and the third NPC are in a negative relationship.

The positive relationship is a relationship that enables action directions of at least two NPCs in the same NPC group to be consistent. In short, the positive relationship is a relationship in which action directions of the NPCs are consistent.

The negative relationship is a relationship that enables action directions of at least two NPCs in the same NPC group to be opposite. In short, the negative relationship is a relationship in which action directions of the NPCs are opposite.

For example, the plurality of NPCs in the NPC group include the NPC 1, the NPC 2, and the NPC 3. The NPC 1 and the NPC 2 are in the positive relationship, and the NPC 2 and the NPC 3 are in the negative relationship. It is assumed that the NPC 1, the NPC 2, and the NPC 3 are all in the activated state. When the virtual character 10 fights with the NPC 2, the computer device modifies, by using the group control logic, the status parameters of the NPC 1, the NPC 2, and the NPC 3. Because the NPC 1 and the NPC 2 are in the positive relationship, a state of the NPC 1 is kept in the activated state, and the NPC 1 also joins a fight between the virtual character 10 and the NPC 2. Because the NPC 2 and the NPC 3 are in the negative relationship, a state of the NPC 3 is modified to the idle state, and the NPC 3 is far away from a fight scene.

In conclusion, in this disclosure, the status parameters of the NPCs in the group are modified by using the group control logic, and then the interaction situation between each NPC and the virtual character is updated by using respective individual control logic of each NPC in combination with the status parameter of each NPC. This disclosure provides a status parameter-based NPC communication solution. An NPC group communicates with an NPC individual by using the status parameter. Behavior control logic of the NPC is mainly located on the individual control logic, and only switching of the status parameter is performed by the group control logic, so that the behavior control logic of the NPC is more systematic. This disclosure further supports customizing behaviors of the NPC in different states (status parameters), and respective individual control logic of each NPC may be customized according to requirements, so that an interaction activity between the NPC and the virtual character is richer and more real.

FIG. 2 is a structural block diagram of a computer system according to an embodiment of this disclosure. A computer system 100 includes: a first terminal 110, a server 120, and a second terminal 130.

A client 111 supporting a virtual environment is installed and run on the first terminal 110. The client 111 may be a multiplayer online battle program. When the first terminal runs the client 111, a user interface of the client 111 is displayed on a screen of the first terminal 110. The client 111 may be any one of an MMOG, an escape shooting game, a virtual reality (VR) application, an augmented reality (AR) program, a three-dimensional map program, a VR game, an AR game, a first-person shooting (FPS) game, a third-person shooting (TPS) game, a multiplayer online battle arena (MOBA) game, and a simulation game (SLG). In this embodiment, an example in which the client 111 is an MMOG game is used for description. The first terminal 110 is a terminal used by a first user 112. The first user 112 uses the first terminal 110 to control a first virtual character located in the virtual environment to perform activities, or operate a virtual item owned by a second virtual character, and the first virtual character may be referred to as a virtual character of the first user 112. The first user 112 may perform operations such as assembling, disassembling, and unloading on a virtual item owned by the first virtual character. This is not limited in this disclosure. For example, the first virtual character is a first virtual human, for example, a simulated human character or a cartoon human character.

A client 131 supporting a virtual environment is installed and run on the second terminal 130. The client 131 may be a multiplayer online battle program. When the second terminal 130 runs the client 131, a user interface of the client 131 is displayed on a screen of the second terminal 130. The client may be any one of an MMOG, an escape shooting game, a VR application, an AR program, a three-dimensional map program, a virtual reality game, an augmented reality game, an FPS, a TPS, an MOBA, and an SLG. In this embodiment, an example in which the client is an MMOG game is used for description. The second terminal 130 is a terminal used by a second user 113. The second user 113 uses the second terminal 130 to control a second virtual character located in the virtual environment to perform activities and operate a virtual item owned by the second virtual character, and the second virtual character may be referred to as a virtual character of the second user 113. For example, the second virtual character is a second virtual human, for example, a simulated human character or a cartoon human character.

In some embodiments, the first virtual character and the second virtual character are located in the same virtual environment. In some embodiments, the first virtual character and the second virtual character may belong to the same camp, the same team, or the same organization, have a friend relationship with each other, or have a temporary communication permission. In some embodiments, the first virtual character and the second virtual character may belong to different camps, different teams, or different organizations, or have a hostile relationship with each other.

In some embodiments, the clients installed on the first terminal 110 and the second terminal 130 are the same, or the clients installed on the two terminals are the same type of clients of different operating system platforms (Android system or iOS system). The first terminal 110 may generally be one of a plurality of terminals, and the second terminal 130 may generally be another one of the plurality of terminals. In this embodiment, the first terminal 110 and the second terminal 130 are merely used as an example for description. Device types of the first terminal 110 and the second terminal 130 are the same or different. The device types include: at least one of a smartphone, a tablet computer, an e-book reader, an MP3 player, an MP4 player, a laptop portable computer, or a desktop computer.

FIG. 2 shows only two terminals, but a plurality of other terminals 140 may access the server 120 in different embodiments. In some embodiments, one or more terminals 140 are also terminals corresponding to a developer. A development and editing platform of the client supporting the virtual environment is installed on the terminal 140. The developer may edit and update the client on the terminal 140, and transmit an updated client installation package to the server 120 by using a wired network or a wireless network. The first terminal 110 and the second terminal 130 may download the client installation package from the server 120 to update the client.

The first terminal 110, the second terminal 130, and the another terminal 140 are connected to the server 120 by using a wireless network or a wired network.

The server 120 includes at least one of one server, a plurality of servers, a cloud computing platform, or a virtualization center. The server 120 is configured to provide a backend service for a client supporting a three-dimensional virtual environment. In some embodiments, the server 120 is responsible for primary computing work, and the terminal is responsible for secondary computing work; or the server 120 is responsible for secondary computing work, and the terminal is responsible for primary computing work; or a distributed computing architecture is used between the server 120 and the terminal to perform collaborative computing.

In an example, the server 120 includes a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the another terminal 140, for example, avatars of the user accounts, nicknames of the user accounts, battle effectiveness indexes of the user accounts, and service zones of the user accounts. The battle service module 124 is configured to provide a plurality of battle rooms for the user to battle, for example, a 1V1 battle, a 3V3 battle, and a 5V5 battle. The user-oriented I/O interface 125 is configured to: establish, by using a wireless network or a wired network, communication between the first terminal 110 and/or the second terminal 130 for data exchange.

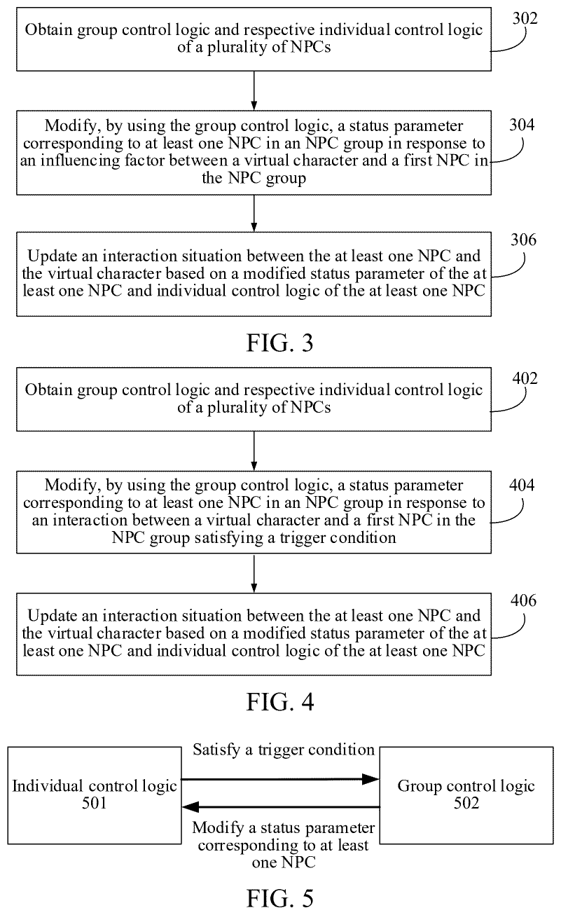

FIG. 3 is a flowchart of a method for controlling a non-player character according to an embodiment of this disclosure. The method may be performed by a computer device, and the computer device may be a terminal or a server in FIG. 2. The method includes:

Operation 302: Obtain group control logic and respective individual control logic of a plurality of NPCs. In an example, each of a plurality of NPCs in an NPC group is controlled through a respective individual control logic of a plurality of individual control logics and a status parameter of the respective NPC.

The group control logic is control logic corresponding to an NPC group, the NPC group includes a plurality of NPCs, and the plurality of NPCs belong to the same NPC group. The control logic is code logic for controlling an action of the NPC. The individual control logic is code logic for controlling a single NPC to perform activities. The group control logic is code logic for controlling the plurality of NPCs to perform activities.

In some embodiments, the NPC has a specific image, or the NPC does not have a specific image.

An example in which the NPC does not have a specific image is used. The NPC may talk to the virtual character, give a gift to the virtual character, or consult a problem with the virtual character in a form of a dialog box. This is not specifically limited in the embodiments of this disclosure.

An example in which the NPC has a specific image is used. The NPC may be an NPC having a character image, or an NPC having an animal image, or an NPC having a mythical beast image or a fairy image, or an NPC having a natural landscape image, or an NPC having an artificial landscape image, but is not limited thereto. This is not specifically limited in the embodiments of this disclosure.

Operation 304: Modify, by using the group control logic, a status parameter corresponding to at least one NPC in an NPC group in response to an influencing factor between a virtual character and a first NPC in the NPC group. In an example, the status parameter corresponding to at least a first NPC in the NPC group is modified, by processing circuitry and through a group control logic, based on a modifying condition between a virtual character and the first NPC in the NPC group.

The influencing factor (or modifying condition) is a factor that can trigger to modify the status parameter of the at least one NPC, for example, an interaction between the NPC and the virtual character, and an action unilaterally performed by the NPC on the virtual character (for example, the NPC detects the virtual character).

The status parameter is configured for indicating a state of the NPC in the virtual environment. In some embodiments, the status parameter includes a parameter configured for indicating at least one of an activated state or an idle state, but is not limited thereto. This is not specifically limited in the embodiments of this disclosure.

The activated state is a state in which the NPC can actively interact with the virtual character. For example, the NPC can actively attack the virtual character. The idle state is a state in which the NPC cannot actively interact with the virtual character. For example, the NPC walks past the virtual character and does not interact with the virtual character.

In an embodiment, the status parameter may alternatively be a customized parameter of another state. For example, a variable A of “whether it is in a fight state” is customized. A value of the variable A being 0 represents that the NPC is not in the fight state, and a value of the variable A being 1 represents that the NPC is in the fight state. For example, a variable B of “whether it is in an idle state” is customized. A value of the variable B being 0 represents that the NPC is not in the idle state, and a value of the variable A being 1 represents that the NPC is in the idle state.

In the following, an example in which the status parameters are parameters of a category of states such as “activated state” and “idle state” is mainly used. In fact, the status parameters may be more specifically set to parameters of a subcategory of states. This is not limited in this disclosure.

In an embodiment, the influencing factor between the virtual character and the first NPC is detected by using individual control logic of the first NPC. If the influencing factor satisfies a condition, a group status parameter (a group state variable) is modified by using the individual control logic of the first NPC. After the group control logic detects that the group status parameter is modified, the group control logic modifies a respective individual status parameter of the at least one NPC in the NPC group.

Operation 306: Update an interaction situation between the at least one NPC and the virtual character based on a modified status parameter of the at least one NPC and individual control logic of the at least one NPC. In an example, an interaction between the NPC and the virtual character is controlled, through the individual control logic of the NPC, based on the modified status parameter of the NPC. Apparatus and non-transitory computer-readable storage medium counterpart embodiments are also contemplated.

For example, for an NPC, after obtaining a modified status parameter of the NPC, the NPC controls itself to interact with the virtual character in combination with individual control logic of the NPC.

In conclusion, in this disclosure, the status parameters of the NPCs in the group are modified by using the group control logic, and then the interaction situation between each NPC and the virtual character is updated by using respective individual control logic of each NPC in combination with the status parameter of each NPC. This disclosure provides a status parameter-based NPC communication solution. An NPC group communicates with an NPC individual by using the status parameter. Behavior control logic of the NPC is mainly located on the individual control logic, and only switching of the status parameter is performed by the group control logic, so that the behavior control logic of the NPC is more systematic. This disclosure further supports customizing behaviors of the NPC in different states (status parameters), and respective individual control logic of each NPC may be customized according to requirements, so that an interaction activity between the NPC and the virtual character is richer and more real.

FIG. 4 is a flowchart of a method for controlling a non-player character according to an embodiment of this disclosure. The method may be performed by a computer device, and the computer device may be a terminal or a server in FIG. 2. The method includes:

Operation 402: Obtain group control logic and respective individual control logic of a plurality of NPCs.

The group control logic is control logic corresponding to an NPC group, the NPC group includes a plurality of NPCs, and the plurality of NPCs belong to the same NPC group. The control logic is code logic for controlling an action of the NPC. The individual control logic is code logic for controlling a single NPC to perform activities. The group control logic is code logic for controlling the plurality of NPCs to perform activities.

Operation 404: Modify, by using the group control logic, a status parameter corresponding to at least one NPC in an NPC group in response to an interaction between a virtual character and a first NPC in the NPC group satisfying a trigger condition.

The interaction includes at least one of common attack, defense, ultimate skill releasing, type chat, voice chat, and gift giving, but is not limited thereto. This is not specifically limited in the embodiments of this disclosure.

The status parameter is configured for indicating a state of the NPC in the virtual environment. In some embodiments, the status parameter includes a parameter configured for indicating at least one of an activated state or an idle state, but is not limited thereto. This is not specifically limited in the embodiments of this disclosure.

The activated state is a state in which the NPC can actively interact with the virtual character. For example, the NPC can actively attack the virtual character. The idle state is a state in which the NPC cannot actively interact with the virtual character. For example, the NPC walks past the virtual character and does not interact with the virtual character.

For example, the trigger condition includes at least one of the following, but is not limited thereto:
duration of an interaction between the virtual character and the first NPC reaches a time threshold;
an operation point of an interaction operation between the first NPC and the virtual character reaches a point threshold;
an interaction event between the virtual character and the first NPC conforms to a predefined interaction event; or
the virtual character does not perform an interaction operation with the first NPC in an activated state, but actively performs an interaction operation with a second NPC in an idle state in the NPC group.

For example, as shown in FIG. 5, in a case that the virtual character and the NPC enter an interaction scene, individual control logic 501 detects the interaction between the NPC and the virtual character in real time. When the interaction between the NPC and the virtual character satisfies the trigger condition, the individual control logic 501 notifies group control logic 502 to modify a status parameter corresponding to at least one NPC in an NPC group. When the group control logic 502 modifies the status parameter of the at least one NPC in the NPC group, the status parameter may be modified based on a priority (activation priority) order of the NPC. Factors affecting the priority of the NPC include: at least one of a specified status parameter, a level of the NPC, a distance between the NPC and the virtual character, and an angle between the NPC and the virtual character, but is not limited thereto.

For example, in a case that the user does not specify the activation order of the NPC, the status parameter is sequentially modified based on the level of the NPC; in a case that the level of the NPC is the same, the status parameter is sequentially modified based on the distance between the NPC and the virtual character; and in a case that the level of the NPC is the same and the distance between the NPC and the virtual character is the same, the status parameter is sequentially modified based on the angle between the NPC and the virtual character.

In some embodiments, when modifying the status parameter of the at least one NPC in the NPC group, the group control logic 502 may modify the status parameter of the at least one NPC in the NPC group based on a pre-configured activation quantity. For example, if the pre-configured activation quantity is infinite, the NPCs in the NPC group are activated as much as possible. In this case, there is no need to determine based on the activation priority order. For example, if the pre-configured activation quantity is three, three NPCs are activated from the NPC group based on the activation priority order.

In some embodiments, if a quantity of NPCs that can be activated in the NPC group is less than the pre-configured activation quantity, the NPCs in the NPC group are activated as much as possible. In this case, there is no need to determine based on the activation priority order.

In some embodiments, the computer device modifies, by using the group control logic, the status parameter corresponding to the at least one NPC in the NPC group in response to the duration of the interaction between the virtual character and the first NPC reaching the time threshold.

The computer device modifies, by using the group control logic, the status parameter of the first NPC from the activated state to the idle state and modifies the status parameter of the second NPC in the NPC group from the idle state to the activated state in response to the duration of the interaction between the virtual character and the first NPC reaching the time threshold.

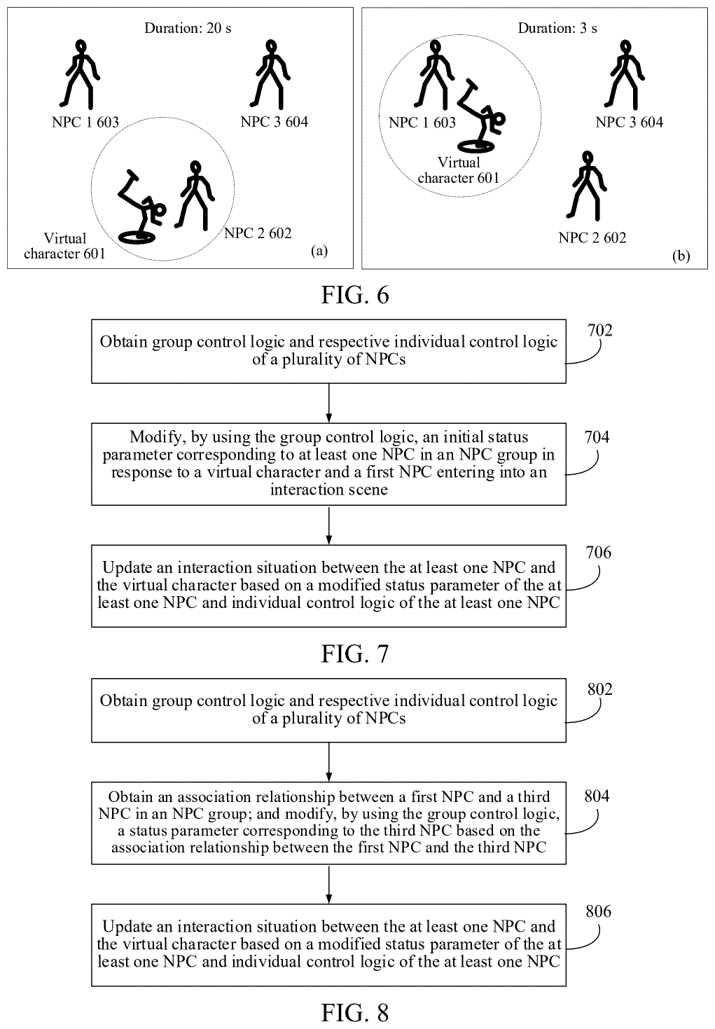

A schematic diagram of an interaction between a virtual character and an NPC is shown in FIG. 6. An NPC 1 603, an NPC 2 602, and an NPC 3 604 that are shown in a part (a) of FIG. 6. The NPC 1 603, the NPC 2 602, and the NPC 3 604 all belong to an NPC group. A time threshold is set to 20 s. When fight duration between a virtual character 601 and the NPC 2 602 reaches 20 s, the computer device modifies, by using group control logic, status parameters of the NPC 1 603, the NPC 2 602, and the NPC 3 604, for example, modifies the status parameter of the NPC 2 602 from an activated state to an idle state, modifies the status parameter of the NPC 1 603 from the idle state to the activated state, and keeps the status parameter of the NPC 3 604 in the idle state. In other words, after attack duration between the virtual character 601 and the NPC 2 602 reaches 20 s, as shown in a part (b) of FIG. 6, the NPC 2 602 no longer continues to fight with the virtual character 601, and the NPC 2 602 moves away from the virtual character 601, but the NPC 1 603 starts to fight with the virtual character 601. The duration in the figure is interaction duration between the virtual character 601 and the NPC. The duration in the figure may be visible, or may be invisible. This is not specifically limited in the embodiments of this disclosure.

In some embodiments, the computer device modifies, by using group control logic, a status parameter corresponding to at least one NPC in an NPC group in response to an operation point of an interaction operation between a first NPC and a virtual character reaching a point threshold.

The operation point is a point corresponding to each operation in a process in which the first NPC interacts with the virtual character. Table 1 shows an operation point correspondence table.

TABLE 1
Operation point correspondence table
Operation point correspondence table

| | | Numerical | |
|---|---|---|---|
| Category | Subcategory | value | Description |
| State | Action ends | −0 | When an operation point is greater than or |
| switching | | | equal to 10, time points for state switching |
| | | | are as follows: (standing, running, common |
| | | | attack, defense ending, and skill ending) |
| State | Any node | −5 | When an operation point is greater than or |
| switching | | | equal to 10, state switching occurs. |
| Action | Common attack | +3 | Triggered only upon a valid hit (for example, |
| | | | 3 points are added after the hit) |
| Action | Skill A | +5 | Triggered only upon a valid hit |
| Action | Skill B | +5 | Triggered only upon a valid hit |
| Action | Ultimate skill | +5 | Triggered only upon a valid hit |
| Action | Defense | +2 | Triggered only upon a valid hit |
| Time-based | No interaction | +1 per second | Situation in which no valid interaction occurs |
| Time-based | Being striked | +1 per second | Being in a striked action |
| Time-based | Reduction in a | −2 per second | Gradual reduction under a negative |
| | negative | | relationship |
| | relationship | | |

In Table 1, it is assumed that the point threshold of the NPC is 20. When the NPC is in the activated state and uses a skill A, if the NPC effectively hits the virtual character, 5 points is added. As time goes by, 1 point is added per second. After a sum of operation points reaches 20, the NPC is modified from the activated state to the idle state. After the state is switched, 5 points are reduced. Then, in the idle state, as time goes by, 2 points are reduced per second until the point reaches 0.

The computer device obtains an operation point correspondence table corresponding to the interaction operation. The computer device modifies, by using the group control logic, the status parameter of the first NPC from the activated state to the idle state and modifies the status parameter of the second NPC from the idle state to the activated state in response to a sum of operation points of the interaction operation between the first NPC and the virtual character reaching a point threshold.

For example, NPCs in the NPC group include the NPC 1, the NPC 2, and the NPC 3. In a process in which the virtual character fight with the NPC 1, when the NPC 1 releases an ultimate skill each time, 5 points are added. In a case that a total of points reaches 15 points, the computer device modifies, by using the group control logic, the status parameters of the NPC 1, the NPC 2, and the NPC 3, for example, modifies the status parameter of the NPC 1 from the activated state to the idle state, and modifies the status parameters of the NPC 2 and the NPC 3 from the idle state to the activated state. In other words, in the process in which the virtual character fights with the NPC 1, after the NPC 1 releases three ultimate skills, the NPC 1 does not continue to fight with the virtual character, and the NPC 1 moves away from the virtual character, but the NPC 2 and the NPC 3 start to fight with the virtual character.

In some embodiments, in response to that the operation point of the interaction operation between the first NPC and the virtual character does not reach the point threshold, the computer device determines that the interaction event between the virtual character and the first NPC conforms to the predefined interaction event, and modifies, by using the group control logic, the status parameter of the first NPC from the idle state to the activated state.

For example, the predefined interaction event includes:
1. A virtual character attacks an NPC.
2. The NPC attacks and hits a monster.
3. The virtual character is located at a specific distance and a specific angle of the NPC.

For example, in a case that the interaction event between the first NPC and the virtual character is “the virtual character attacks the first NPC”, the computer device determines that the interaction event between the virtual character and the first NPC conforms to the predefined interaction event, and the computer device modifies, by using the group control logic, the status parameter of the first NPC from the idle state to the activated state.

For example, in a case that the interaction event between the first NPC and the virtual character is “a distance between the virtual character and the first NPC is less than 100 m”, the computer device determines that the interaction event between the virtual character and the first NPC conforms to the predefined interaction event, and the computer device modifies, by using the group control logic, the status parameter of the first NPC from the idle state to the activated state.

In some embodiments, in a case that the virtual character does not perform an interaction operation with the first NPC in the activated state, but performs an interaction operation with the second NPC in the NPC group in the idle state, the computer device modifies, by using the group control logic, the status parameter of the first NPC from the activated state to the idle state, and modifies the status parameter of the second NPC from the idle state to the activated state.

For example, in a process in which the virtual character interacts with the first NPC in the activated state, when the virtual character actively interacts with the second NPC in the idle state, the status parameter of the first NPC is modified from the activated state to the idle state, and the status parameter of the second NPC is modified from the idle state to the activated state by using the group control logic.

For example, the first NPC and the second NPC are in the same NPC group. The first NPC in the activated state fights with the virtual character, and the second NPC in the idle state is paced alongside. When the virtual character actively attacks the second NPC, the computer device modifies the status parameter of the first NPC from the activated state to the idle state, and modifies the status parameter of the second NPC from the idle state to the activated state by using the group control logic. In other words, the second NPC starts to fight with the virtual character, and the first NPC ends the fight and leaves the virtual character.

In some embodiments, in response to the distance between the virtual character and the first NPC being less than a distance threshold, the computer device modifies, by using the group control logic, the status parameter corresponding to the at least one NPC in the NPC group.

For example, the distance threshold is set to 3 meters. In a case that the distance between the virtual character and the first NPC is less than 3 meters, the virtual character and the NPC enter the interaction scene, and the status parameter corresponding to the at least one NPC in the NPC group is modified by using the group control logic. For example, the status parameter of the first NPC is modified to the activated state, the first NPC releases the ultimate skill to the virtual character, and other NPCs in the NPC group still remain in the idle state. The other NPCs respectively leave a fight region between the first NPC and the virtual character.

In some embodiments, in response to the virtual character and the first NPC being located in the same position region, the computer device modifies, by using the group control logic, the status parameter corresponding to the at least one NPC in the NPC group.

In some embodiments, the same position region includes at least one of the same floor, the same car, the same cavern, or the same combat zone, but is not limited thereto. This is not specifically limited in the embodiments of this disclosure.

For example, an example in which the same position region is the same floor is used. When the virtual character and the first NPC are on the same floor, the virtual character and the NPC enter the interaction scene, and the status parameter corresponding to the at least one NPC in the NPC group is modified by using the group control logic. For example, the status parameter of the first NPC is modified to the activated state, the first NPC actively attacks the virtual character, or the first NPC releases the ultimate skill to the virtual character, while other NPCs in the NPC group still remain in the idle state.

In some embodiments, in response to time in which the virtual character and the first NPC are located at the same position region reaching a co-position time threshold, the computer device modifies, by using the group control logic, the status parameter corresponding to the at least one NPC in the NPC group.

For example, the co-position time threshold is set to one minute. An example in which the same position region is the same floor is used, when time in which the virtual character and the first NPC are located on the same floor exceeds one minute, the virtual character and the NPC enter the interaction scene, and the status parameter corresponding to the at least one NPC in the NPC group is modified by using the group control logic. For example, the status parameter of the first NPC is modified from the activated state to the idle state, and the second NPC in the NPC group is modified from the idle state to the activated state. The second NPC actively attacks the virtual character, or the second NPC releases the ultimate skill to the virtual character.

Operation 406: Update an interaction situation between the at least one NPC and the virtual character based on a modified status parameter of the at least one NPC and individual control logic of the at least one NPC.

For example, for an NPC, after obtaining a modified status parameter of the NPC, the NPC controls itself to interact with the virtual character in combination with individual control logic of the NPC.

In conclusion, according to the method provided in this embodiment, operation duration, the operation point, and whether the interaction operation between the virtual character and the first NPC satisfies a preset interaction event are detected. The group control logic is triggered in different trigger manners to modify the status parameter corresponding to the at least one NPC in the NPC group to which the first NPC belongs. Then, the interaction situation between each NPC and the virtual character is updated by using the respective individual control logic of each NPC in combination with the status parameter of each NPC. This disclosure provides a status parameter-based NPC communication solution. When detecting that a condition is reached, an NPC individual notifies an NPC group to modify a status parameter of the NPC individual, and then, each NPC individual updates an interaction operation between the NPC individual and the virtual character in combination with individual control logic of the NPC individual and the modified status parameter, so that behavior control logic of the NPC is more systematic.

FIG. 7 is a flowchart of a method for controlling a non-player character according to an embodiment of this disclosure. The method may be performed by a computer device, and the computer device may be a terminal or a server in FIG. 2. The method includes:

Operation 702: Obtain group control logic and respective individual control logic of a plurality of NPCs.

The group control logic is control logic corresponding to an NPC group, the NPC group includes a plurality of NPCs, and the plurality of NPCs belong to the same NPC group. The control logic is code logic for controlling an action of the NPC. The individual control logic is code logic for controlling a single NPC to perform activities. The group control logic is code logic for controlling the plurality of NPCs to perform activities.

Operation 704: Modify, by using the group control logic, an initial status parameter corresponding to at least one NPC in an NPC group in response to a virtual character and a first NPC entering an interaction scene.

In some embodiments, NPCs in the NPC group each correspond to a default status parameter at when a battle starts. For example, the NPCs in the NPC group are dispersedly distributed at different positions, an NPC in an activated state can actively attack the virtual character, and an NPC in an idle state is in a wandering state.

The initial status parameters are default status parameters of the NPCs in the NPC group when the battle starts.

For example, the NPCs includes an NPC 1, an NPC 2, and an NPC 3. The NPC 1, the NPC 2, and the NPC 3 belong to the same NPC group, and default states of the NPC 1, the NPC 2, and the NPC 3 are idle states when the battle starts, that is, the NPC 1, the NPC 2, and the NPC 3 do not actively attack the virtual character. For example, the computer device modifies, by using the group control logic, the initial status parameter corresponding to the at least one NPC in the NPC group in response to the virtual character attacking the first NPC.

In some embodiments, the computer device modifies, by using the group control logic, the initial status parameter corresponding to the at least one NPC in the NPC group in response to the virtual character entering a field of view of the first NPC.

The field of view is a front visual range centered on the NPC. For example, the field of view a sector range using a position of the NPC as a center of a circle, or a circle range using a position of the NPC as a center of a circle, or an annular range using a position of the NPC as a center of a circle, or a regular graphic range using a position of the NPC as a center, or an irregular graphic range using a position of the NPC as a center, but is not limited thereto. This is not specifically limited in the embodiments of this disclosure. A size of the field of view is not specifically limited.

For example, when the virtual character enters a field of view of the NPC 2, the computer device modifies, by using the group control logic, initial status parameters corresponding to the NPC 1, the NPC 2, and the NPC 3, to modify the NPC 2 from an idle state to an activated state, and keep the NPC 1 and the NPC 3 in the idle state. In this case, the computer device updates interaction situations between the NPC 1, the NPC 2, and the NPC 3 and the virtual character based on the status parameters respectively corresponding to the NPC 1, the NPC 2, and the NPC 3 and the individual control logic respectively corresponding to the NPC 1, the NPC 2, and the NPC 3. That is, the NPC 2 actively attacks the virtual character, and the NPC 1 and the NPC 3 walk away.

In some embodiments, the NPC carries a blind spot detection prop, and the blind spot detection prop is configured for detecting a virtual character within a blind spot range of the NPC. The computer device modifies, by using the group control logic, the initial status parameter corresponding to the at least one NPC in the NPC group in response to the virtual character entering a blind spot range of the first NPC, that is, when the virtual character enters a detection range of the blind spot detection prop of the first NPC. The blind spot range is a back-surface invisible range centered on the NPC.

Operation 706: Update an interaction situation between the at least one NPC and the virtual character based on a modified status parameter of the at least one NPC and individual control logic of the at least one NPC.

For example, for an NPC, after obtaining a modified status parameter of the NPC, the NPC controls itself to interact with the virtual character in combination with individual control logic of the NPC.

In conclusion, according to the method provided in this embodiment, whether the virtual character attacks the NPC or enters the field of view of the NPC is detected, thereby triggering the group control logic to modify the initial status parameter corresponding to the at least one NPC in the NPC group to which the first NPC belongs. Then, the interaction situation between each NPC and the virtual character is updated by using respective individual control logic of each NPC in combination with the modified initial status parameter of each NPC. This disclosure provides a status parameter-based NPC communication solution. Behavior control logic of the NPC is more systematic.

FIG. 8 is a flowchart of a method for controlling a non-player character according to an embodiment of this disclosure. The method may be performed by a computer device, and the computer device may be a terminal or a server in FIG. 2. The method includes:

Operation 802: Obtain group control logic and respective individual control logic of a plurality of NPCs.

The group control logic is control logic corresponding to an NPC group, the NPC group includes a plurality of NPCs, and the plurality of NPCs belong to the same NPC group. The control logic is code logic for controlling an action of the NPC. The individual control logic is code logic for controlling a single NPC to perform activities. The group control logic is code logic for controlling the plurality of NPCs to perform activities.

Operation 804: Obtain an association relationship between a first NPC and a third NPC in an NPC group; and modify, by using the group control logic, a status parameter corresponding to the third NPC based on the association relationship between the first NPC and the third NPC.

In some embodiments, the association relationship includes at least one of a positive relationship or a negative relationship, but is not limited thereto. This is not specifically limited in the embodiments of this disclosure.

The positive relationship is a relationship that enables action directions of at least two NPCs in the same NPC group to be consistent. For example, the positive relationship includes at least one of a relationship of lovers, a relationship of close friends, a relationship of playmates, or a relationship between a master and an apprentice, but is not limited to. This is not specifically limited in the embodiments of this disclosure.

The negative relationship is a relationship that enables action directions of at least two NPCs in the same NPC group to be opposite. For example, the negative relationship includes at least one of a hostile relationship or an attribute-incompatible relationship, but is not limited thereto. This is not specifically limited in the embodiments of this disclosure.

The status parameters of the first NPC and the third NPC are modified, by using the group control logic, to be in a consistent state in a case that the first NPC and the third NPC are in the positive relationship; and the status parameters of the first NPC and the third NPC are modified, by using the group control logic, to be in an opposite state in a case that the first NPC and the third NPC are in the negative relationship.

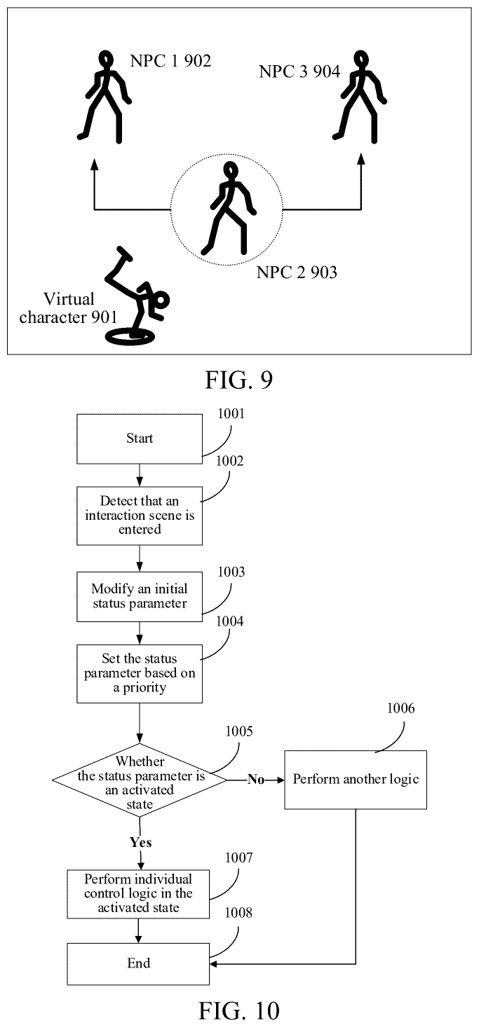

For example, FIG. 9 is a schematic diagram of an interaction operation between a virtual character and an NPC. NPCs in an NPC group include an NPC 1 902, an NPC 2 903, and an NPC 3 904. The NPC 1 902 and the NPC 2 903 are in the positive relationship, and the NPC 2 903 and the NPC 3 904 are in the negative relationship. It is assumed that the NPC 1 902, the NPC 2 903, and the NPC 3 904 are all in the activated state. When the virtual character 901 fights with the NPC 2 903, the computer device modifies, by using the group control logic, the status parameters of the NPC 1 902, the NPC 2 903, and the NPC 3 904. Because the NPC 1 902 and the NPC 2 903 are in the positive relationship, a state of the NPC 1 902 is kept in the activated state, and the NPC 1 902 also joins a fight between the virtual character 901 and the NPC 2 903. Because the NPC 2 903 and the NPC 3 904 are in the negative relationship, a state of the NPC 3 904 is modified to the idle state, and the NPC 3 904 is far away from a fight scene.

In some embodiments, the computer device obtains the association relationship between the first NPC and the third NPC in the NPC group; and modifies, by using the group control logic, a behavior parameter corresponding to the third NPC based on the association relationship between the first NPC and the third NPC.

In a case that the first NPC and the third NPC are in the positive relationship, behavior parameters of the first NPC and the third NPC are modified to be in a consistent state by using the group control logic, that is, the first NPC and the third NPC may simultaneously perform a behavior. For example, when the first NPC performs an attack behavior, the third NPC may also perform the attack behavior. In a case that the first NPC and the third NPC are in the negative relationship, behavior parameters of the first NPC and the third NPC are modified to be in an opposite state by using the group control logic, that is, the first NPC and the third NPC cannot simultaneously perform a behavior. For example, when the first NPC performs an attack behavior, the third NPC cannot perform the attack behavior.

Operation 806: Update an interaction situation between at least one NPC and a virtual character based on a modified status parameter of the at least one NPC and individual control logic of the at least one NPC.

For example, for an NPC, after obtaining a modified status parameter of the NPC, the NPC controls itself to interact with the virtual character in combination with individual control logic of the NPC.

In conclusion, according to the method provided in this embodiment, association relationships between different NPCs in the same group are obtained, to trigger the group control logic to modify a status parameter of each NPC based on the association relationships. Then, an interaction situation between each NPC and the virtual character is updated based on respective individual control logic in combination with the modified status parameter of each NPC. This disclosure provides a status parameter-based NPC communication solution. Behavior control logic of the NPC is more systematic.

FIG. 10 is a flowchart of a method for controlling an NPC according to an embodiment of this disclosure. The method may be performed by a computer device, and the computer device may be a terminal or a server in FIG. 2. The method includes:

Operation 1001: Start.

Operation 1002: Detect that an interaction scene is entered.

For example, the computer device detects whether a virtual character and an NPC enter the interaction scene.

In some embodiments, a manner for entering the interaction scene includes: at least one of the following: the virtual character attacks a first NPC or the virtual character enters a field of view of a first NPC, but is not limited thereto. This is not specifically limited in the embodiments of this disclosure.

Operation 1003: Modify an initial status parameter.

For example, in a case that the virtual character and the NPC enter the interaction scene, an initial status parameter corresponding to at least one NPC in an NPC group is modified by using group control logic.

For example, when the virtual character enters a field of view of the NPC 2, the computer device modifies, by using the group control logic, initial status parameters corresponding to the NPC 1, the NPC 2, and the NPC 3, to modify the NPC 2 from an idle state to an activated state, and keep the NPC 1 and the NPC 3 in the idle state. In this case, the computer device updates interaction situations between the NPC 1, the NPC 2, and the NPC 3 and the virtual character based on the status parameters respectively corresponding to the NPC 1, the NPC 2, and the NPC 3 and the individual control logic respectively corresponding to the NPC 1, the NPC 2, and the NPC 3. That is, the NPC 2 actively attacks the virtual character, and the NPC 1 and the NPC 3 walk away.

Operation 1004: Set the status parameter based on a priority.

For example, when the group control logic modifies the initial status parameter corresponding to the at least one NPC in the NPC group, the group control logic modifies the initial status parameter based on a priority of the NPC.

The priority of the NPC includes: at least one of a specified status parameter, a level of the NPC, a distance between the NPC and the virtual character, and an angle between the NPC and the virtual character, but is not limited thereto.

For example, in a case that the user does not specify an activation order of the NPC, the status parameter is sequentially modified based on the level of the NPC; in a case that the level of the NPC is the same, the status parameter is sequentially modified based on the distance between the NPC and the virtual character; and in a case that the level of the NPC is the same and the distance between the NPC and the virtual character is the same, the status parameter is sequentially modified based on the angle between the NPC and the virtual character.

Operation 1005: Whether the status parameter is an activated state.

For example, after the group control logic modifies the status parameters of the NPCs in the NPC group, whether the status parameter of the first NPC is in the activated state is determined. In a case that the status parameter of the first NPC is in the activated state, operation 1007 is performed; and in a case that the status parameter of the first NPC is not in the activated state, operation 1006 is performed.

Operation 1006: Perform another logic.

In a case that the status parameter of the first NPC is not in the activated state, the another logic is performed, that is, individual control logic in the unactivated state is performed.

In some embodiments, the another logic includes at least one of escaping behavior logic, item pickup behavior logic, and pacing behavior logic, but is not limited thereto.

Operation 1007: Perform individual control logic in the activated state.

In a case that the status parameter of the first NPC indicates the activated state, the individual control logic in the activated state is performed, that is, the first NPC attacks the virtual character and starts to fight with the virtual character.

### Operation 1008: End.

In conclusion, according to the method provided in this embodiment, whether the virtual character attacks the NPC or enters the field of view of the NPC is detected, thereby triggering the group control logic to modify the initial status parameter corresponding to the at least one NPC in the NPC group to which the first NPC belongs, so that the interaction activity between the NPC and the virtual character is richer and more real, and the behavior of the NPC is closer to the virtual character controlled by a real user, which improves user experience.

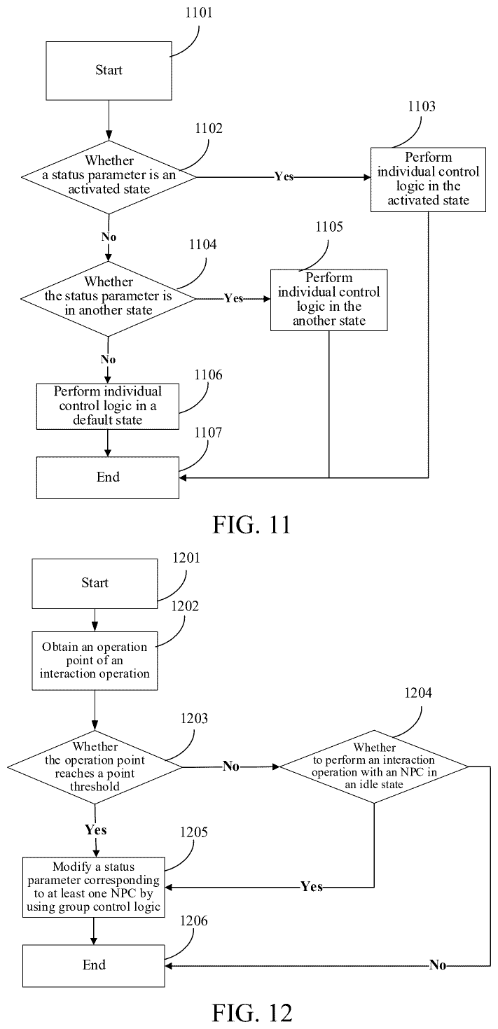

FIG. 11 is a flowchart of a method for controlling an individual NPC according to an embodiment of this disclosure. The method may be performed by a computer device, and the computer device may be a terminal or a server in FIG. 2. The method includes:

Operation 1101: Start.

Operation 1102: Whether a status parameter is an activated state.

For example, for the individual NPC, whether a status parameter of the individual NPC is an activated state is determined. In a case that the individual NPC is in the activated state, operation 1103 is performed; and in a case that the individual NPC is in an unactivated state, operation 1104 is performed.

Operation 1103: Perform individual control logic in the activated state.

For example, in a case that the individual NPC is in the activated state, the individual control logic in the activated state is performed, that is, a first NPC attacks a virtual character and starts to fight with the virtual character.

Operation 1104: Whether the status parameter is in another state.

For example, in a case that the individual NPC is in the unactivated state, whether the status parameter of the individual NPC is in the another state is determined. In a case that the status parameter of the individual NPC is in the another state, operation 1105 is performed; and in a case that the status parameter of the individual NPC is not in the another state, operation 1106 is performed.

In some embodiments, the another state includes at least one of escaping behavior logic, item pickup behavior logic, and pacing behavior logic, but is not limited thereto.

Operation 1105: Perform individual control logic in the another state.

For example, in a case that the status parameter of the individual NPC is another state, the individual NPC is controlled to perform the individual control logic in the another state. For example, the NPC is controlled to pick up materials.

Operation 1106: Perform individual control logic in a default state.

For example, in a case that the status parameter of the individual NPC is neither the activated state nor the another state, the individual NPC is controlled to perform the individual control logic in the default state.

### Operation 1107: End.

In conclusion, according to the method provided in this embodiment, a behavior of the individual NPC is changed by changing a state of the NPC, so that the behavior of the NPC is closer to the virtual character controlled by a real user, thereby improving user experience.

FIG. 12 is a flowchart of a method for controlling an NPC according to an embodiment of this disclosure. The method may be performed by a computer device, and the computer device may be a terminal or a server in FIG. 2. The method includes:

Operation 1201: Start.

Operation 1202: Obtain an operation point of an interaction operation.

The operation point is a point corresponding to each operation in a process in which a first NPC interacts with a virtual character.

For example, the computer device obtains an operation point correspondence table corresponding to the interaction operation, and determines, based on the operation point correspondence table, a sum of operation points of the interaction operation between the first NPC and the virtual character.

Operation 1203: Whether the operation point reaches a point threshold.

For example, the computer device determines whether the sum of operation points of the interaction operation between the first NPC and the virtual character reaches the point threshold. In a case that the sum of the operation points of the interaction operation between the first NPC and the virtual character reaches the point threshold, operation 1205 is performed; and in a case that the sum of operation points of the interaction operation between the first NPC and the virtual character does not reach the point threshold, operation 1204 is performed.

Operation 1204: Whether to perform an interaction operation with an NPC in an idle state.

For example, in a case that the sum of operation points of the interaction operation between the first NPC and the virtual character does not reach the point threshold, whether the virtual character performs the interaction operation with the NPC in the idle state is determined. In a case that the virtual character performs the interaction operation with the NPC in the idle state, operation 1205 is performed; and in a case that the virtual character does not perform the interaction operation with the NPC in the idle state, operation 1206 is performed.

Operation 1205: Modify a status parameter corresponding to at least one NPC by using group control logic.

For example, in a case that the sum of the operation points of the interaction operations between the first NPC and the virtual character reaches the point threshold, the status parameter of the first NPC is modified from the activated state to the idle state and the status parameter of the second NPC is modified from the idle state to the activated state by using the group control logic.

For example, NPCs in the NPC group include the NPC 1, the NPC 2, and the NPC 3. In a process in which the virtual character fight with the NPC 1, when the NPC 1 releases an ultimate skill each time, 5 points are added. In a case that the points reach 15 points, the computer device modifies, by using the group control logic, the status parameters of the NPC 1, the NPC 2, and the NPC 3, for example, modifies the status parameter of the NPC 1 from the activated state to the idle state, and modifies the status parameters of the NPC 2 and the NPC 3 from the idle state to the activated state. In other words, in the process in which the virtual character fights with the NPC 1, after the NPC 1 releases three ultimate skills, the NPC 1 does not continue to fight with the virtual character, and the NPC 1 moves away from the virtual character, but the NPC 2 and the NPC 3 start to fight with the virtual character.

In some embodiments, in a case that the sum of operation points of the interaction operation between the first NPC and the virtual character does not reach the point threshold, but the virtual character performs the interaction operation with the NPC in the idle state, the status parameter of the first NPC is modified from the activated state to the idle state, and the status parameter of the second NPC is modified from the idle state to the activated state by using the group control logic.

### Operation 1206: End.

In conclusion, according to the method provided in this embodiment, the operation point of the interaction operation between the virtual character and the first NPC is detected, and in this manner, the group control logic is triggered to modify the status parameter corresponding to the at least one NPC in the NPC group to which the first NPC belongs, so that the interaction between the virtual character and the NPC is more linked, and the interaction activity between the NPC and the virtual character is richer and more real, and the behavior of the NPC is closer to the virtual character controlled by a real user, thereby improving user experience.

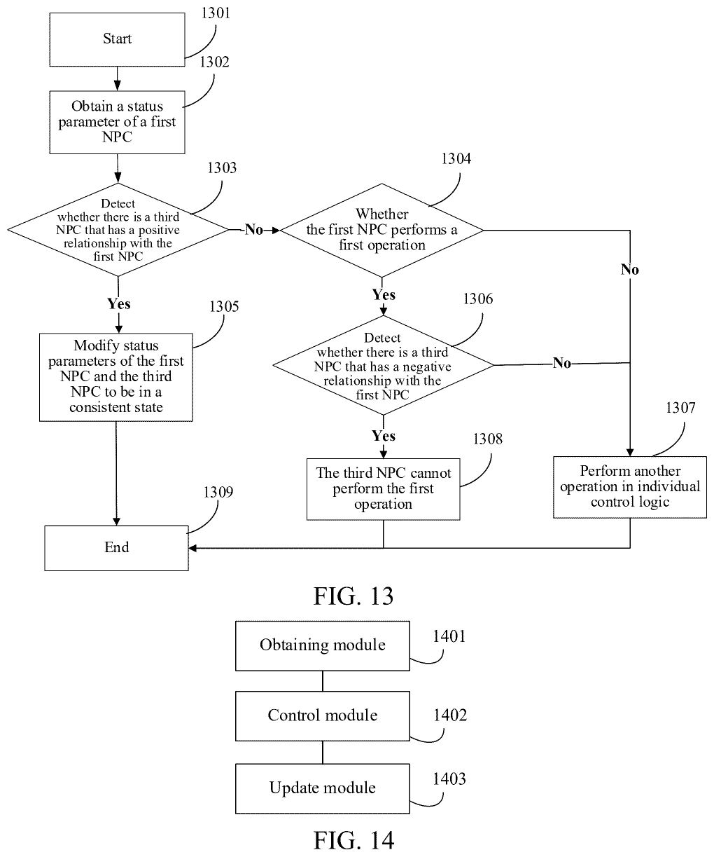

FIG. 13 is a flowchart of a method for controlling an NPC according to an embodiment of this disclosure. The method may be performed by a computer device, and the computer device may be a terminal or a server in FIG. 2. The method includes:

Operation 1301: Start.

Operation 1302: Obtain a status parameter of a first NPC.

For example, the computer device obtains a status parameter of a first NPC, and obtains an association relationship between the first NPC and a third NPC in an NPC group.

The status parameter includes an activated state and an idle state.

In some embodiments, the association relationship includes at least one of a positive relationship or a negative relationship, but is not limited thereto. This is not specifically limited in the embodiments of this disclosure.

The positive relationship is a relationship that enables action directions of at least two NPCs in the same NPC group to be consistent. For example, the positive relationship includes at least one of a relationship of lovers, a relationship of close friends, a relationship of playmates, or a relationship between a master and an apprentice, but is not limited to. This is not specifically limited in the embodiments of this disclosure.

The negative relationship is a relationship that enables action directions of at least two NPCs in the same NPC group to be opposite. For example, the negative relationship includes at least one of a hostile relationship or an attribute-incompatible relationship, but is not limited thereto. This is not specifically limited in the embodiments of this disclosure.

Operation 1303: Detect whether there is a third NPC that has a positive relationship with the first NPC.

For example, after the status parameter of the first NPC is obtained, whether there is the third NPC that has the positive relationship with the first NPC is detected. In a case that the third NPC that has the positive relationship with the first NPC exists in an NPC group, operation 1305 is performed; and in a case that the third NPC that has the positive relationship with the first NPC does not exist in the NPC group, operation 1304 is performed.

Operation 1304: Whether the first NPC performs a first operation.

For example, in a case that the third NPC that has the positive relationship with the first NPC does not exist in the NPC group, whether the first NPC performs the first operation is determined. In a case that the first NPC performs the first operation, operation 1306 is performed, and in a case that the first NPC does not perform the first operation, operation 1307 is performed.

The first operation includes at least one of a running behavior, an attack behavior, a flying behavior, or a crossing behavior, but is not limited thereto. This is not specifically limited in the embodiments of this disclosure.

Operation 1305: Modify status parameters of the first NPC and the third NPC to be in a consistent state.

For example, in a case that the third NPC that has the positive relationship with the first NPC exists in the NPC group, the status parameters of the first NPC and the third NPC are modified to be in a consistent state by using group control logic.

For example, NPCs in the NPC group include the NPC 1, the NPC 2, and the NPC 3. The NPC 1 and the NPC 2 are in the positive relationship, and the NPC 2 and the NPC 3 are in the negative relationship. It is assumed that the NPC 1, the NPC 2, and the NPC 3 are all in the activated state. When the virtual character fights with the NPC 2, the computer device modifies, by using the group control logic, the status parameters of the NPC 1, the NPC 2, and the NPC 3. Because the NPC 1 and the NPC 2 are in the positive relationship, a state of the NPC 1 is kept in the activated state, and the NPC 1 also joins a fight between the virtual character and the NPC 2. Because the NPC 2 and the NPC 3 are in the negative relationship, a state of the NPC 3 is modified to the idle state, and the NPC 3 is far away from a fight scene.

Operation 1306: Detect whether there is a third NPC that has a negative relationship with the first NPC.

For example, in a case that the first NPC performs the first operation, whether there is the third NPC that has the negative relationship with the first NPC is detected. In a case that the third NPC that has the negative relationship with the first NPC exists in the NPC group, operation 1308 is performed; and in a case that the third NPC that has the negative relationship with the first NPC does not exist in the NPC group, operation 1307 is performed.

Operation 1307: Perform another operation in individual control logic.

In a case that the third NPC that has the association relationship with the first NPC does not exist in the NPC group, the first NPC and the third NPC are controlled to perform the another operation in the individual control logic based on respective corresponding individual control logic.

Operation 1308: The third NPC cannot perform the first operation.

For example, in a case that the third NPC that has the negative relationship with the first NPC exists in the NPC group, and in a case that the first NPC performs the first operation, the third NPC cannot be controlled to perform the first operation.

For example, in a case that the first NPC and the third NPC are in the negative relationship, behavior parameters of the first NPC and the third NPC are modified to opposite states by using the group control logic, that is, the first NPC and the third NPC cannot simultaneously perform a behavior. For example, when the first NPC performs an attack behavior, the third NPC also cannot perform the attack behavior.

### Operation 1309: End.

In conclusion, according to the method provided in this embodiment, association relationships between different NPCs in the same group are obtained, and the NPCs in the NPC group can make a more intelligent response, so that the interaction activity between the NPC and the virtual character is richer and more real, and the behavior of the NPC is closer to the virtual character controlled by a real user, thereby improving user experience.

FIG. 14 is a schematic diagram of a structure of an apparatus for controlling a non-player character according to an embodiment of this disclosure. The apparatus may be implemented as an entire computer device or a part of the computer device by using software, hardware, or a combination thereof. The apparatus includes an obtaining module 1401, a control module 1402, and an update module 1403.

The obtaining module 1401 is configured to obtain group control logic and respective individual control logic of a plurality of NPCs, the group control logic being control logic corresponding to an NPC group, and the NPC group including the plurality of NPCs.

The control module 1402 is configured to: modify, by using the group control logic, a status parameter corresponding to at least one NPC in the NPC group in response to an influencing factor between a virtual character and a first NPC in the NPC group.

The update module 1403 is configured to update an interaction situation between the at least one NPC and the virtual character based on a modified status parameter of the at least one NPC and the individual control logic of the at least one NPC.

In some embodiments, the control module 1402 is configured to: modify, by using the group control logic, the status parameter corresponding to the at least one NPC in the NPC group in response to an interaction between the virtual character and the first NPC in the NPC group satisfying a trigger condition.

In some embodiments, the control module 1402 is configured to: modify, by using the group control logic, the status parameter corresponding to the at least one NPC in the NPC group in response to duration of the interaction between the virtual character and the first NPC in the NPC group reaching a time threshold.

In some embodiments, the control module 1402 is configured to: modify, by using the group control logic, a status parameter of the first NPC from an activated state to an idle state, and modify, by using the group control logic, a status parameter of a second NPC in the NPC group from the idle state to the activated state in response to the duration of the interaction between the virtual character and the first NPC in the NPC group reaching the time threshold, the activated state being a state in which the NPC is capable of actively interacting with the virtual character, and the idle state being a state in which the NPC is incapable of actively interacting with the virtual character.

In some embodiments, the control module 1402 is configured to: modify, by using the group control logic, the status parameter corresponding to the at least one NPC in the NPC group in response to an operation point of an interaction operation between the first NPC in the NPC group and the virtual character reaching a point threshold.

In some embodiments, the obtaining module 1401 is configured to query an operation point correspondence table to obtain a sum of the operation points of the interaction operation between the first NPC in the NPC group and the virtual character, the operation point correspondence table including an operation point corresponding to each interaction operation.

In some embodiments, the control module 1402 is configured to: modify, by using the group control logic, a status parameter of the first NPC from an activated state to an idle state, and modify, by using the group control logic, a status parameter of a second NPC in the NPC group from the idle state to the activated state in response to the sum of the operation points of the interaction operation between the first NPC and the virtual character reaching the point threshold, the activated state being a state in which the NPC is capable of actively interacting with the virtual character, and the idle state being a state in which the NPC is incapable of actively interacting with the virtual character.

In some embodiments, the control module 1402 is configured to: modify, by using the group control logic, a status parameter of the first NPC from an idle state to an activated state in response to an interaction event between the virtual character and the first NPC in the NPC group conforming to a predefined interaction event, the activated state being a state in which the NPC is capable of actively interacting with the virtual character, and the idle state being a state in which the NPC is incapable of actively interacting with the virtual character.

In some embodiments, the control module 1402 is configured to: modify, by using the group control logic, the status parameter of the first NPC from the activated state to the idle state, and modify the status parameter of the second NPC from the idle state to the activated state in a case that the virtual character does not perform an interaction operation with the first NPC in the NPC group in the activated state but performs an interaction operation with the second NPC in the NPC group in the idle state.

In some embodiments, the control module 1402 is configured to: modify, by using the group control logic, an initial status parameter corresponding to the at least one NPC in the NPC group in response to the virtual character and the first NPC in the NPC group entering an interaction scene, the initial status parameter being a default status parameter when a battle starts.

In some embodiments, the control module 1402 is configured to: modify, by using the group control logic, the initial status parameter corresponding to the at least one NPC in the NPC group in response to the virtual character attacking the first NPC.

In some embodiments, the control module 1402 is configured to: modify, by using the group control logic, the initial status parameter corresponding to the at least one NPC in the NPC group in response to the virtual character entering a field of view of the first NPC.

In some embodiments, the obtaining module 1401 is configured to obtain an association relationship between the first NPC and a third NPC in the NPC group.

In some embodiments, the control module 1402 is configured to: modify, by using the group control logic, a status parameter corresponding to the third NPC based on the association relationship between the first NPC and the third NPC.

The association relationship includes a positive relationship, and the positive relationship is a relationship that enables action directions of at least two NPCs in the same NPC group to be consistent. In some embodiments, the control module 1402 is configured to: modify, by using the group control logic, the status parameters of the first NPC and the third NPC to be in a consistent state in a case that the first NPC and the third NPC are in the positive relationship.

The association relationship includes a negative relationship, and the negative relationship is a relationship that enables action directions of at least two NPCs in the same NPC group to be opposite. In some embodiments, the control module 1402 is configured to: modify, by using the group control logic, status parameters of the first NPC and the third NPC to be in an opposite state in a case that the first NPC and the third NPC are in the negative relationship.

In an embodiment, the control module 1402 is configured to: modify, by using the group control logic, the status parameter corresponding to the at least one NPC in the NPC group based on an activation priority order in response to the influencing factor between the virtual character and the first NPC in the NPC group.

In an embodiment, the control module 1402 is configured to: modify, by using the group control logic, the status parameter corresponding to the at least one NPC in the NPC group based on a pre-configured activation quantity in response to the influencing factor between the virtual character and the first NPC in the NPC group.

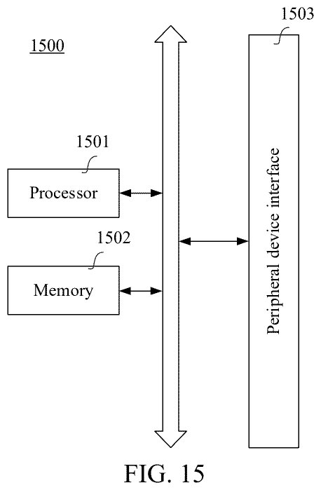

FIG. 15 is a block diagram of a structure of a computer device 1500 according to an embodiment of this disclosure. The computer device 1500 may be a portable mobile terminal, such as: a smartphone, a tablet computer, a Moving Picture Experts Group Audio Layer III (MP3) player, and a Moving Picture Experts Group Audio Layer IV (MP4) player. The computer device 1500 may be further referred to as another name such as user equipment or a portable terminal.

The computer device 1500 includes: processing circuitry, such as a processor 1501, and a memory 1502.

The processor 1501 may include one or more processing cores, such as a 4-core processor or an 8-core processor. Processing circuitry, such as the processor 1501, may be implemented by using at least one hardware form of a digital signal processing (DSP), a field programmable gate array (FPGA), and a programmable logic array (PLA). The processor 1501 may also include a main processor and a coprocessor. The main processor is a processor configured to process data in an active state, also referred to as a central processing unit (CPU). The coprocessor is a low-power consumption processor configured to process data in a standby state. In some embodiments, the processor 1501 may be integrated with a graphics processing unit (GPU). The GPU is configured to be responsible for rendering and drawing content that needs to be displayed on a display screen. In some embodiments, the processor 1501 may alternatively include an artificial intelligence (AI) processor. The AI processor is configured to process a computing operation related to machine learning.

The memory 1502 may include one or more computer-readable storage media. The computer-readable storage medium may be tangible and non-transitory. The memory 1502 may alternatively include a high-speed random access memory and a non-volatile memory, for example, one or more disk storage devices and flash storage devices. In some embodiments, the non-transitory computer-readable storage medium in the memory 1502 is configured to store at least one instruction. The at least one instruction is executed by the processor 1501 to implement the method for controlling a non-player character provided in the embodiments of this disclosure.

In some embodiments, the computer device 1500 may further include: a peripheral device interface 1503 and at least one peripheral device. Specifically, the peripheral device includes: at least one of a radio frequency circuit, a touch display screen, a camera, an audio circuit, or a power supply.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

A person skilled in the art may understand that the structure shown in FIG. 15 does not constitute any limitation on the computer device 1500, and the computer device 1500 may include more components or fewer components than those shown in the figure, or some components may be combined, or a different component deployment may be used.

An embodiment of this disclosure further provides a computer device. The computer device includes a processor and a memory, the memory having at least one program stored therein, the at least one computer program being loaded and executed by the processor to implement the method for controlling a non-player character provided in the foregoing method embodiments.

An embodiment of this disclosure further provides a computer-readable storage medium, such as a non-transitory computer-readable storage medium. The computer-readable storage medium has at least one computer program stored therein, the at least one computer program being loaded and executed by a processor to implement the method for controlling a non-player character provided in the foregoing method embodiments.

An embodiment of this disclosure further provides a computer program product. The computer program product includes a computer program, the computer program being stored in a computer-readable storage medium; and the computer program being read and executed by a processor of a computer device from the computer-readable storage medium, to cause the computer device to implement the method for controlling a non-player character provided in the foregoing method embodiments.

What is claimed is:

1. A method for controlling a non-player character (NPC), the method comprises:
controlling each of a plurality of NPCs in an NPC group through a respective individual control logic of a plurality of individual control logics and a status parameter of the respective NPC;
modifying, by processing circuitry and through a group control logic, the status parameter corresponding to at least a first NPC in the NPC group based on a modifying condition between a virtual character and the first NPC in the NPC group; and
controlling, through the individual control logic of the NPC, an interaction between the NPC and the virtual character based on the modified status parameter of the NPC.

2. The method according to claim 1, wherein the modifying condition includes an interaction between the virtual character and the first NPC in the NPC group satisfying a trigger condition.

3. The method according to claim 2, wherein the trigger condition includes a duration of the interaction between the virtual character and the first NPC in the NPC group reaching a time threshold.

4. The method according to claim 3, wherein
the modifying comprises:
modifying, through the group control logic, the status parameter of the first NPC from an activated state to an idle state, and
modifying, through the group control logic, the status parameter of a second NPC in the NPC group from the idle state to the activated state based on the duration of the interaction between the virtual character and the first NPC in the NPC group reaching the time threshold;
the NPC is configured to actively interact with the virtual character in the activated state; and
the NPC is configured to not interact with the virtual character in the idle state.

5. The method according to claim 2, wherein the modifying condition includes a total number of interaction operations between the first NPC in the NPC group and the virtual character reaching a point threshold.

6. The method according to claim 5, wherein
the modifying comprises:
modifying, through the group control logic, the status parameter of the first NPC from an activated state to an idle state, and
modifying, through the group control logic, the status parameter of a second NPC in the NPC group from the idle state to the activated state based on the total number of interaction operations between the first NPC and the virtual character reaching the point threshold;
the NPC is configured to actively interact with the virtual character in the activated state; and
the NPC is configured to not interact with the virtual character in the idle state.

7. The method according to claim 2, wherein
the modifying condition includes an interaction event between the virtual character and the first NPC in the NPC group conforming to a predefined interaction event, and
the NPC is configured to actively interact with the virtual character in an activated state, and
the NPC is configured to not interact with the virtual character in an idle state.

8. The method according to claim 1, wherein
the modifying condition includes the virtual character and the first NPC in the NPC group entering an interaction scene; and
the modifying includes modifying, through the group control logic, an initial status parameter corresponding to the NPC in the NPC group, the initial status parameter being a default status parameter when a battle starts.

9. The method according to claim 8, wherein the modifying comprises:
modifying, through the individual control logic of the first NPC, a group status parameter corresponding to the NPC group based on the virtual character and the first NPC in the NPC group entering the interaction scene; and
modifying, through the group control logic, the initial status parameter corresponding to the NPC in the NPC group based the group control logic detecting that the group status parameter changes.

10. The method according to claim 8, wherein the modifying comprises:
modifying, through the group control logic, the initial status parameter corresponding to the NPC in the NPC group based on the virtual character attacking the first NPC in the NPC group.

11. The method according to claim 8, wherein the modifying comprises:
modifying, through the group control logic, the initial status parameter corresponding to the NPC in the NPC group based on the virtual character entering a field of view of the first NPC in the NPC group.

12. The method according to claim 1, further comprising:
obtaining an association relationship between the first NPC and a third NPC in the NPC group; and
modifying, through the group control logic, the status parameter corresponding to the third NPC based on the association relationship between the first NPC and the third NPC.

13. The method according to claim 12, wherein
the association relationship includes a positive relationship in which action directions of the NPCs are consistent; and
the modifying includes modifying, through the group control logic, the status parameters of the first NPC and the third NPC to be in a consistent state when the first NPC and the third NPC are in the positive relationship.

14. The method according to claim 12, wherein
the association relationship includes a negative relationship in which action directions of the NPCs are opposite; and
the modifying includes modifying, through the group control logic, the status parameters of the first NPC and the third NPC to be in an opposite state when the first NPC and the third NPC are in the negative relationship.

15. The method according to claim 1, wherein the modifying comprises:
modifying, through the group control logic, the status parameter corresponding to the NPC in the NPC group based on an activation priority order and the modifying condition between the virtual character and the first NPC in the NPC group.

16. The method according to claim 1, wherein the modifying comprises:
modifying, through the group control logic, the status parameter corresponding to the NPC in the NPC group based on a pre-configured activation quantity and the modifying condition between the virtual character and the first NPC in the NPC group.

17. An information processing apparatus, comprising:
processing circuitry configured to:
control each of a plurality of non-player characters (NPCs) in an NPC group through a respective individual control logic of a plurality of individual control logics and a status parameter of the respective NPC;
modify, through a group control logic, the status parameter corresponding to at least a first NPC in the NPC group based on a modifying condition between a virtual character and the first NPC in the NPC group; and
control, through the individual control logic of the NPC, an interaction between the NPC and the virtual character based on the modified status parameter of the NPC.

18. The information processing apparatus according to claim 17, wherein the modifying condition includes an interaction between the virtual character and the first NPC in the NPC group satisfying a trigger condition.

19. The information processing apparatus according to claim 18, wherein the trigger condition includes a duration of the interaction between the virtual character and the first NPC in the NPC group reaching a time threshold.

20. A non-transitory computer-readable storage medium, storing instructions which when executed by a processor cause the processor to perform:
controlling each of a plurality of non-player characters (NPCs) in an NPC group through a respective individual control logic of a plurality of individual control logics and a status parameter of the respective NPC;
modifying, through a group control logic, the status parameter corresponding to at least a first NPC in the NPC group based on a modifying condition between a virtual character and the first NPC in the NPC group; and
controlling, through the individual control logic of the NPC, an interaction between the NPC and the virtual character based on the modified status parameter of the NPC.
